(19) United States
(12) Patent Application Publication
(10) Pub. No.: US 2009/0212467 A1
(43) Pub. Date: Aug. 27, 2009

(54) Expandable Bladder

(75) Inventors: Nanni Marco Nahmias, Milano (IT); Massimo Loprevite, Milano (IT); Roberta Bongiovanni, Torino (IT); Anna Di Gianni, Torino (IT); Aldo Priola, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI PNEUMATICI S.P.A., Milano (IT)

(21) Appl. No.: 11/883,128

(22) PCT Filed: Jan. 26, 2005
(86) PCT No.: PCT/EP05/00995

§ 371 Date: Oct. 8, 2008

(51) Int. Cl. B29C 33/50; B29D 30/06; C08L 21/00

(52) U.S. Cl. 264/501; 425/52; 525/276

(57) ABSTRACT

An expandable bladder for manufacturing pneumatic tyres is used in combination with a vulcanisation apparatus including, for example, a mould having a plurality of sidewall plates and tread sectors that, when the mould is closed, delimit a moulding cavity suitable for housing the green pneumatic tyre to be cured. The expandable bladder includes an elastomeric material obtained by curing an elastomeric composition which includes at least one butyl rubber and at least one compound having at least one double bond and an at least partially fluorinated alkyl or polyoxyalkylene chain.

### BACKGROUND OF THE INVENTION

The present invention relates to an expandable bladder suitable for manufacturing pneumatic tyres.

### PRIOR ART

As reported, for example, by U.S. Pat. No. 5,728,311 (in the name of Goodyear Tire & Rubber), conventionally pneumatic tyres are produced by moulding and curing a green or uncured tyre in a moulding press. The green tyre is pressed outwardly against a mould surface by means of an inner fluid-expandable bladder. By this method the green tyre is shaped against the outer mould surface which defines the tyre tread pattern and configuration of the sidewalls. By application of heat and pressure the tyre is moulded and cured at elevated temperatures.

In general practice, the expansion of the bladder is accomplished by application of internal pressure to the inner bladder cavity which is provided by a fluid such as gas, hot water and/or steam which also participates in the transfer of heat for the curing or vulcanisation of the tyre. At the end of the vulcanisation, the mould is opened, the bladder is collapsed by removal of its internal fluid pressure and the tyre is removed from the tyre mould.

It is recognized that there is substantial relative movement between the outer contacting surface of the bladder and the inner surface of the tyre during the expansion phase of the bladder. Likewise, there is considerable relative movement between the outer contacting surface of the bladder and the cured inner surface of tyre during the collapse and the stripping of the bladder from the tyre after the tyre has been moulded and vulcanised.

The bladder surface can tend to stick to a tyre's inner surface after the tyre is cured and during the bladder collapsing. This adhesion may cause roughening of the bladder surface and/or of the tyre surface if it is not controlled. This reduces bladder durability and can produce defective tyres. For this reason, it is conventional practice to pre-coat the bladder and/or the inner surface of the green or uncured tyre with a lubricant in order to provide lubricity between the outer bladder surface and inner tyre surfaces during the entire moulding operation. This lubricant can be a silicon polymer dispersed in a solvent or water, or a silicon oil added with a mineral filler.

It is to be appreciated that the release of the tyre from its expandable bladder in an industrial manufacturing setting is associated with both the phenomenon of release (to prevent sticking) and the phenomenon of lubrication (to enhance slipping) between the bladder and the adjacent tyre surfaces. The release aspect refers to the basic ability to avoid adhesion, and the aspect of lubrication relates to enhancing the ability of the surfaces to slip and enable a movement of the bladder with respect to the tyre.

Butyl rubber is commonly used in bladders for manufacturing tyres. Butyl rubber is a copolymer of predominantly isobutylene with small amounts of diene monomers to give sufficient unsaturation to allow the butyl rubber to be cross-linked.

Fluorinated materials attracted attention in view of the hydrophobic and oleophobic characteristics, the low friction coefficient and the thermal and chemical resistance thereof. On the other side, the admixture of fluorinated compounds in elastomeric compositions such those employed in the pneumatic tyre manufacturing and, in particular, in the expandable bladders production, gives rise to problems due to the very low compatibility of the fluorinated compounds.

U.S. Pat. No. 5,728,311 relates to expandable cure bladders made of a rubber compound comprising at least one fluorinated ethylene polymer (PFE) dispersed therein in particulate form, desirably in an amount of from 0.5-1 phr to 10-30 phr. The particle size of the particulate is of 1-25 μm, however the smaller particle sizes are preferred because they disperse better during the rubber mixing processes.

JP 2004-026897 (in the name of Yokohama Rubber Co.) relates to an elastomeric composition for bladder for tyre vulcanisation, said composition containing 50-100 phr of a fluorinated rubber copolymer, for example, a fluoro silicone rubber, such as a copolymer of trifluoro propylmethyl siloxane and dimethylsiloxane; and tetrafluoroethylene copolymers, such as a copolymer of perfluoro vinyl ether and tetrafluoroethylene.

### SUMMARY OF THE INVENTION

The Applicant observed that the need for an expandable bladder having anti-adhesive properties and suitable mechanical characteristics to bear the thermal and physical stresses of the vulcanisation process for manufacturing tyre, was felt.

The mechanical properties (such as break strength, modulus and elongation at break) of the bladder should not be impaired by the presence of fluorinated material in the rubber composition thereof, and should endure for several manufacturing cycles at high temperatures.

Moreover, the Applicant observed that the concentration of the fluorinated material in the cured bladder, and especially in the bladder outer surface, should be maintained substantially unchanged over time. In other words, the surface migration of the fluorinated material should not give place to a loss of this material thus causing a downfall of lubrication on the surface of the bladder and a decay of the performance thereof.

The Applicant found that an expandable bladder comprising at least one compound having at least one double bond and an at least partially fluorinated chain, shows desirable mechanical features in term, for example, of break strength and elongation at break, such to allow an efficient use of the bladder for more than two hundred manufacturing cycles, together with anti-adhesive characteristics allowing an easy detachment of the bladder from the cured tyre, more specifically from the cured tyre portion contacting the bladder during the vulcanisation, i.e. the inner liner.

Therefore, the present invention relates to an expandable bladder for manufacturing pneumatic tyres, comprising an elastomeric material obtained by curing an elastomeric composition comprising at least one butyl rubber and at least one compound having at least one double bond and an at least partially fluorinated alkyl or polyoxyalkylene chain.

Advantageously, the expandable bladder of the invention is obtained by curing an elastomeric composition comprising at least one compound of formula (I)

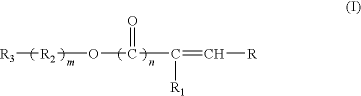

wherein
m and n are independently 0 or 1;
R is hydrogen or a methyl, ethyl, propyl or phenyl group;
R₁ is hydrogen or a (C₁-C₆)alkyl, aryl or aryl(C₁-C₄)alkyl group;
R₂ is a C₁-C₄ alkylene chain optionally including at least one group selected from —OH, —NH—, —NH₂, —O—, >CO and —CONH—; and
R₃ is a group selected from an at least partially fluorinated C₄-C₂₀ alkyl chain linear or branched, or a group having repeating units according to formula (Ia)

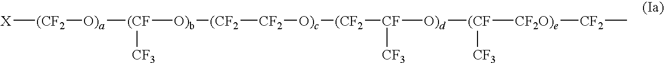

wherein (a+b+c+d)≧0;
a, b, c, d and e are independently zero or integers from 1 to 10;
said units being statistically distributed along the chain; and
X is hydrogen, fluoride, a CF₃ group or a group of formula (Ia′)

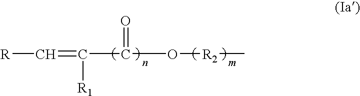

wherein m, n, R, R₁ and R₂ are as from above.

The at least one group selected from —OH, —NH—, —NH₂, —O—, —CONH— and >CO optionally included in the alkylene chain R₂ is to be intended as interrupting such chain or as a substituent on a carbon atom thereof, according to the chemical valence.

For the purpose of the present description and of the claims that follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

For the purposes of the present description and of the claims, the term “phr” means the parts by weight of a given component of the elastomeric composition per 100 parts by weight of the elastomeric base.

Advantageously, the elastomeric composition of the bladder according to the invention comprises at least one curable rubber selected from natural rubber and synthetic isoprene rubber.

According to one preferred embodiment, the butyl rubber may be selected from isobutyl rubbers.

Preferably, said isobutyl rubbers may be selected from homopolymers of isoolefin monomer containing from 4 to 12 carbon atoms or copolymers obtained by polymerizing a mixture comprising at least one isoolefin monomer containing from 4 to 12 carbon atoms and at least one conjugated diolefin monomer containing from 4 to 12 carbon atoms.

Preferably, said copolymers contain from 70 wt % 99.5 wt %, preferably from 90 wt % to 99 wt %, of at least one isoolefin monomer, and from 30 wt % to 0.5 wt %, preferably from 10 wt % to 1 wt % of at least one conjugated diolefin monomer.

Preferably, the isoolefin monomer may be selected from C₄-C₁₂ compounds such as, for example, isobutylene, isobutene, 2-methyl-1-butene, 3-methyl-1-butene, 2-methyl-2-butene, methyl vinyl ether, indene, vinyltrimethylsilane, hexene, 4-methyl-1-pentene, or mixtures thereof. Isobutylene is preferred.

Preferably, the conjugated diolefin monomer may be selected from C₄ to C₁₄ compounds such as, for example, isoprene, 1,3-butadiene, 2,3-dimethyl-1,3-butadiene, myrcene, 6,6-dimethyl-fulvene, hexadiene, cyclopentadiene, piperylene, or mixtures thereof. Isoprene is preferred.

Other polymerizable monomers such as, for example, styrene, styrene optionally substituted with C₁-C₄-alkyl groups or halogen groups, such as, for example, methylstyrene, dichlorostyrene, may also be present in the abovementioned isobutyl rubbers.

According to a further preferred embodiment, the butyl rubber may be selected from halogenated butyl rubbers.

Halogenated butyl rubbers are derived from the butyl rubbers above reported by reaction with chlorine or bromine according to methods known in the art. For example, the butyl rubber may be halogenated in hexane diluent at from 40° C. to 60° C. using bromine or chlorine as halogenating agent. Preferably, the halogen contents is from 0.1 wt % to 10 wt %, preferably from 0.5 wt % to 5 wt %, based on the weight of the halogenated butyl rubber.

Halogenated butyl rubbers that are particularly preferred according to the present invention are chlorobutyl rubber, or bromobutyl rubber.

According to a further preferred embodiment, the butyl rubber (a) may be selected from halogenated isobutylene/p-alkylstyrene copolymers.

Said halogenated isobutylene/p-alkylstyrene copolymers may be selected from copolymers of an isoolefin containing from 4 to 7 carbon atoms such as, for example, isobutylene, and of a p-alkylstyrene such as, for example, p-methylstyrene.

Preferred products are those derived from the halogenation of a copolymer between an isoolefin containing from 4 to 7 carbon atoms such as, for example, isobutylene, and a comonomer such as p-alkylstyrene in which at least one of the substituents on the alkyl groups present in the styrene unit is a halogen, preferably chlorine or bromine.

Preferably, from 50 to 95 phr of butyl rubber (polymers or copolymers of isobutylene) are present in the expandable bladder of the invention.

Small amounts (e.g. up to 20 phr, preferably up to 5 phr) of diene based elastomers such as neoprene and chloroprene rubber may be used. Neoprene rubber is also known as poly(chloroprene). Other halogen containing rubbers may be included in amounts up to 20 phr, preferably up to 10 phr.

Optionally, the present elastomeric composition contains conventional additives including fillers, peptizing agents, stearic acid, accelerators, sulphur vulcanizing agents, resin for curing, antiozonants, antioxidants, processing oils, activators, initiators, plasticizers, waxes, prevulcanization inhibitors, extender oils and the like.

The elastomeric composition of the bladder of the invention can be cured with sulphur cure and/or resin cure systems, the latter being preferred. Examples of resin cure systems are phenolic resins, in particular, phenolic resins obtained by condensation polymerization of a phenolic compound and formaldehyde, commonly known as resol and novolac. In resol resin, the phenol bears reactive groups such as methylol groups. A resorcinol/formaldehyde resin cure systems is preferred to avoid reversion.

Advantageously, resin cure systems are used in amounts of from 1 to 10 phr.

When a sulphur cure system is used, the amount of sulphur is from 0.1 to 5 phr, preferably from 0.2 to 3 phr. Representative sulphur cure systems include elemental sulphur or sulphur donating vulcanising agents, for example, an amine disulfide, polymeric polysulfide or sulphur olefin adducts.

Accelerators for sulphur cured systems may be used in amounts from 0.1 to 5 phr, preferably from 0.5 to 2.5 phr. These types of accelerators are well known and include amines, disulfides, guanidines, thioureas, thiols, thiazoles, thiurams, sulfenamides, dithiocarbamates and xanthates. Blends of two or more accelerators may be used. Preferably the primary accelerator is a sulfenamide. If a secondary accelerator is used, it is preferably a guanidine, dithiocarbamate, or thiuram compound.

Optionally, antioxidants and antiozonants are added to the bladder composition. Antioxidants prevent oxidative crosslinking or oxidative chain scission so that the modulus and fracture properties of the rubber are substantially unaffected during exposure to oxidation, especially at elevated temperatures. Antioxidants for rubber compounds in general and for butyl rubber more specifically are well known to the art. Antidegradants include antioxidants and antiozonants. Suitable amounts are from 0.1 to 10 phr, preferably from 2 to 6 phr. Antiozonants are compounds that prevent chain scission due to exposure to ozone. They are also well known to the art. Antidegradants include monophenols, bisphenols, thiophenols, polyphenols, hydroquinone derivatives, phosphites, phosphate blends, thioesters, naphthylamines, diphenol amines as well as other diaryl amine derivatives, para-phenylenediamines, quinolines, and blended amines.

Fillers are preferably incorporated into the expandable bladder composition. They may be used in amounts from 10 to 200 phr, preferably from 30 to 100 phr. A preferred filler is carbon black. Carbon black can be used in amounts from 25 to 85 phr. Typical carbon blacks that can be used include, for example, acetylene black, N110, N121, N220, N231, N234, N242, N293, N299, N326, N330, N332, N339, N343, N347, N351, N358, N375, N472, N539, N550, N683, N754, and N765.

Silica can be used in addition to or in the place of carbon black. Silicas are generally described as precipitated silicas, fume silicas and various naturally occurring materials having substantial amounts of SiO₂ therein.

Various oils and waxes may be used in expandable bladder formulation depending upon the compatibility of the oils and waxes with the butyl rubber and the other components of the rubber formulation. Waxes include microcrystalline wax and paraffin wax. Oils include aliphatic-naphthenic aromatic resins, polyethylene glycol, petroleum oils, ester plasticizers, vulcanized vegetable oils, pine tar, phenolic resin, polymeric esters, castor oil and rosins. Oils and waxes can be used in conventional individual amounts from 1 to 10 phr.

Fatty acids such as stearic acid, palmitic acid and oleic acid may be used in amounts from 0.1 to 5 phr, with a range of from 0.2 to 1 phr being preferred. Zinc oxide may be present, for example, in amounts from 0.5 to 10 phr.

Advantageously, the elastomeric composition of the bladder of the invention comprises the compound of formula (a) in an amount of from 0.1 to 6 phr (substantially corresponding to 0.06-3.6 wt %), more preferably from 1 to 4 phr (substantially corresponding to 0.6-2.5 wt %).

In formula (I), R is preferably hydrogen.

In formula (I) R₁ is preferably hydrogen.

In formula (I), X is preferably a group of formula (Ia′)

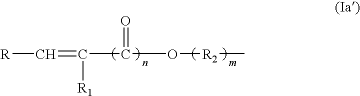

wherein m, n, R, R₁ and R₂ are as from above.

Preferably, R₃ is a C₄-C₂₀ at least partially, more preferably totally fluorinated alkyl chain linear or branched.

Preferably, R₃ is a C₆-C₁₅ at least partially, more preferably totally fluorinated alkyl chain linear or branched.

When, in formula (I), R₃ is a C₄-C₂₀ at least partially fluorinated alkyl chain linear or branched, m is 0.

When, in formula (I) R₃ is a group of formula (Ia) as defined above, m is 1. R₂ is preferably a C₁-C₄ alkylene chain optionally including at least one group selected from —OH, —NH—, —NH₂, —O—, >CO and —CONH—. More preferably, R₂ is a C₁-C₄ alkylene chain including at least one group selected from —OH, —O— and —CONH—.

Advantageously, R₃ is totally fluorinated.

Advantageously, when R₃ is a group of formula (Ia) as defined above, the compound of formula (I) is an oligomer having a molecular weight ranging from 500 to 3,000.

Examples of compounds of formula (I) according to the present invention are:
2-perfluorodecylethylacrylate,
perfluorohexylethylacrylate,
perfluorooctylethylacrylate,
perfluorododecylethylacrylate,
perfluorooctylpropylacrylate,
perfluorooctyldecylacrylate.

In another aspect the present invention relates to a curable elastomeric composition comprising at least one butyl rubber and at least one compound having at least one double bond and an at least partially fluorinated alkyl or polyoxyalkylene chain.

Advantageously, the curable elastomeric composition comprises at least one compound of formula (I)

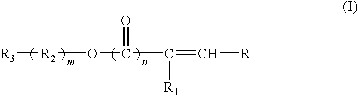

wherein
m and n are independently 0 or 1;
R is hydrogen or a methyl, ethyl, propyl or phenyl group;
R₁ is hydrogen or a (C₁-C₆)alkyl, aryl or aryl(C₁-C₄)alkyl group;
R₂ is a C₁-C₄ alkylene chain optionally including at least one group selected from —OH, —NH—, —NH₂, —O—, >CO and —CONH—; and
R₃ is a group selected from an at least partially fluorinated C₄-C₂₀ alkyl chain linear or branched, or a group having repeating units according to formula (Ia)

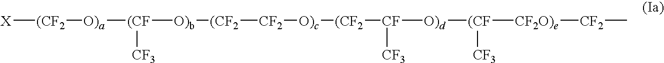

wherein (a+b+c+d)≧0;
a, b, c, d and e are independently zero or integers from 1 to 10;
said units being statistically distributed along the chain; and
X is hydrogen, fluoride, a CF₃ group or a group of formula (Ia′)

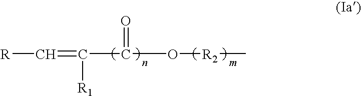

wherein m, n, R, R₁ and R₂ are as from above.

In a further aspect, the present invention relates to a process for manufacturing a pneumatic tyre, said process comprising the steps of:
forming a crude tyre;
inserting the crude tyre in a vulcanisation mould;
inserting an expandable bladder into the crude tyre;
   wherein said expandable bladder comprises an elastomeric material obtained by curing an elastomeric composition comprising at least one butyl rubber and at least one compound having at least one double bond and an at least partially fluorinated alkyl or polyoxyalkylene chain.

The thus obtained rubber mixture is used to manufacture the expandable bladder of the invention by moulding in an injection moulding machine, transfer moulding machine or compression moulding machine, as that described, for example, by U.S. Pat. No. 5,580,513. The material from the Banbury may be extruded as a slug. The cure time will depend on heating rate and the gauge (thickness) of the expandable bladder; for example, the process can be effected for about 20 minutes at a temperature of about 200° C. for the injection moulding, and for about 30 minutes at a temperature of about 190° C. for the transfer moulding.

### BRIEF DESCRIPTION OF THE DRAWING

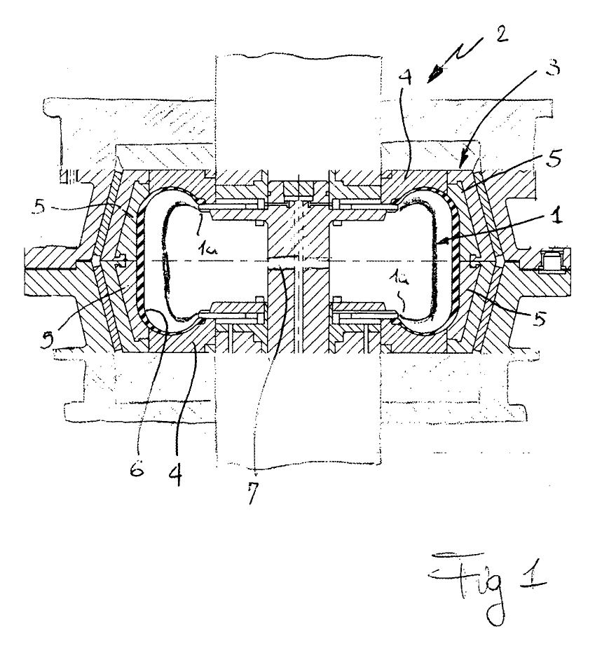

The present invention will now be illustrated in further detail by means of a number of illustrative embodiments, with reference to the attached FIG. 1 schematically showing the cross section of a vulcanising apparatus incorporating an expandable bladder according to the invention while expanding inside a crude pneumatic tyre.

### DETAILED DESCRIPTION OF THE PREFERRED EMBODIMENTS

According to FIG. 1, the expandable bladder (1) is used in combination with a vulcanisation apparatus (2) comprising a mould (3) having a plurality of sidewall plates (4) and tread sectors (5) that, when mould (3) is closed, delimit a moulding cavity suitable for housing the green pneumatic tyre (6) to be cured.

The bladder (1) has a substantially toroidal form and at least a circumferential edge, preferably two, provided with anchoring means (1a) for operatively engaging the bladder (1) to the mould (3). An inlet (7) for steam or other vulcanisation fluid is provided in the mould (3) to reach the radially inner surface of the bladder (1) and expand the bladder (1) so as to press the green tyre (6) against the sidewall plates (4) and the tread sectors (5) suitably provided with reliefs (not illustrated). The pressure exerted makes said reliefs yield a desired tread pattern on the tread band, and graphic signs and technical indications on the sidewalls of the tyre.

The mould (3) is operatively associated with means for heating the green tyre (6) to be vulcanised. Said heating means cooperate with the fluid reaching the bladder (1) in cross-linking the elastomeric material of the crude tyre (6).

At the end of the cycle, the cured tyre (6) is disengaged from the expandable bladder (1) and removed from the mould (3).

### Example 1

### Elastomeric Composition and Characteristics Thereof

An elastomeric composition for manufacturing an expandable bladder according to the invention was prepared by a two-step process with the ingredients as from Table 1.

TABLE 1
1^{st} Step

| | | |
|---|---|---|
| Butyl rubber | 95 | phr |
| Chloroprene | 5 | phr |
| N 339 carbon black | 45.6 | phr |
| Paraffin oil | 4.8 | phr |
| Ribetak ® 7530 | 6.5 | phr |
| ZnO | 5 | phr |
| Stearic acid | 0.6 | phr |

2^{nd} Step

| | | |
|---|---|---|
| 2-perfluorodecylethylacrylate | 1.6 | phr |

Ribetak ® 7530: octyl-phenol formaldehyde resin with active methylol groups, by Schenectady France.

The ingredients of the 1^{st} Step were admixed to provide a mixture A. 15 g of mixture A were introduced in a Brabender Plastometer, set at 60° C., and worked-up at 60 rpm. After 60 seconds, 0.15 g (1.6 phr) of 2-perfluorodecylethylacrylate was added, and the blending was kept on under the same conditions for additional 3 minutes.

The resulting composition hereinafter referred to as “Composition 1”) was vulcanised and moulded at 195° C. under a pressure of 100 atm for 18 minutes using a Collin mechanical press.

Analogously, an elastomeric composition was prepared using the ingredients of the 1^{st} Step only, i.e. without a fluorinated compound of formula (I), and hereinafter referred to as “Reference”.

The surface properties of Composition 1 and Reference were measured by means of contact angle measurements (sessile drop technique). Such technique is described, for example, by Garbassi F. et al., “Polymer surfaces. From physics to technology” J. Wiley and Sons, Ltd. West Sussex, UK, 1994. The contact angle is referred to hexadecane and soybean oil. More particularly, the contact angle amounts to the angle defined between the sample surface (i.e. the baseline of a droplet of the liquid in question resting on the surface of elastomeric material) and the tangent to the droplet boundary passing through the point of intersection with the sample surface. The greatest the contact angle, the smallest the surface energy of the elastomeric material and the smallest the compatibility between the liquid droplet and the material. In other words, a droplet with high surface tension resting on a low energy material tends to form a substantially spherical shape, i.e. a high contact angle. Conversely, when the surface energy of the material exceeds the liquid surface tension, the droplet tends to form a flatter, lower profile shape, i.e. a low contact angle. The results are given in Table 2.

TABLE 2

| | Hexadecane | Soybean oil |
|---|---|---|
| Sample | γ = 28 N/m at 25° C. | γ = 32 N/m at 25° C. |
| Reference | 0 | 0 |
| Composition 1 | 66 | 72 |

γ = surface tension of the liquid.

The contact angle values set forth in Table 2 indicate that the sample of Composition 1 containing the compound of formula (I) according to the invention shows a high oleophobic capacity, while the Reference composition is highly oleophilic. Therefore a correspondingly high anti-adhesive capacity with respect to elastomeric compositions forming a crude tyre is to be expected.

The mechanical characteristics of a sample of Composition 1 are set forth in Table 3.

TABLE 3

| | Reference | | Composition 1 | |
|---|---|---|---|---|
| MH [dNm] 195° C. | 9.5 | [dNm] | 8.8 | [dNm] |
| CA100% | 1.6 | [MPa] | 1.5 | [MPa] |
| CA300% | 4.6 | [MPa] | 4.4 | [MPa] |
| Break strength | 15 | [MPa] | 14.5 | [MPa] |
| Elongation at break | 745 | [%] | 730 | [%] |

| | | |
|---|---|---|
| Hardness IRHD 23° C. | 61 | 60 |
| Flex Fatigue | 2 samples at 500 | 2 samples at 500 |
| | Kcycles (none broke) | Kcycles (none broke) |

The rheometric properties MH are measured according to ISO standard 6502, using a Monsanto rheometer MDR2000E at a temperature of 195° C.

The static mechanical properties (CA50%-300%, break and elongation at break) are according to Standard ISO 37:1994, and measured at room temperature. IRHD hardness is measured according to ISO standard 48:1994 at 23° C.

The flex (flexural) fatigue resistance was evaluated at 70° C., according to ISO standard 132:199 (De Mattia test).

The mechanical characteristics of Composition 1 are substantially similar to those of the Reference composition not containing a fluorinated compound according to the invention. Said characteristics are maintained after an accelerated ageing test performed at 180° C. for 24 hours. The results are set forth in the following Table 4.

TABLE 4

| | Reference | Composition 1 |
|---|---|---|
| CA100% | 2.7 [MPa] | 2.6 [MPa] |
| CA300% | 7.9 [MPa] | 7.7 [MPa] |
| Break strength | 11.5 [MPa] | 11.0 [MPa] |
| Contact angle (soybean oil) | 0 | 70 |
| Contact angle (hexadecane) | 0 | 64 |

### Example 2

### Elastomeric Composition and Characteristics Thereof

An elastomeric composition (hereinafter referred to as Composition 2) for manufacturing an expandable bladder according to the invention was prepared as from example 1, but using 0.15 g (1.6 phr) of perfluoropolyether bisurethane methacrylate PFEUMA 1000 prepared according to Priola et al., Macromol. Chem. Phys., 198, 1893-1907 (1997). The characteristics of the Composition 2 are provided hereinbelow and compared with the Reference composition.

TABLE 5

| | Hexadecane | Soybean oil |
|---|---|---|
| Sample | γ = 28 at 25° C. | γ = 32 at 25° C. |
| Reference | 0 | 0 |
| Composition 2 | 68 | 65 |

The contact angle values set forth in Table 5 indicate that the sample of Composition 2 containing the compound of formula (I) according to the invention shows a high oleophobic capacity, while the Reference composition is highly oleophilic. Therefore a correspondingly high anti-adhesive capacity with respect to elastomeric compositions forming a crude tyre is to be expected.

The mechanical characteristics of a sample from Composition 2, evaluated as those of Composition 1 above, are set forth in Table 6.

TABLE 6

| | Reference | | Composition 2 | |
|---|---|---|---|---|
| MH [dNm] 195° C. | 9.5 | [dNm] | 8.6 | [dNm] |
| CA100% | 1.6 | MPa | 1.4 | MPa |
| CA300% | 4.6 | MPa | 4.2 | MPa |
| Break strength | 15 | MPa | 14 | MPa |

| | | |
|---|---|---|
| Elongation at break | 745% | 780% |
| Hardness IRHD 23° C. | 61 | 60 |
| Flex Fatigue | 2 samples at 500 | 2 samples at 500 |
| | Kcycles (none broke) | Kcycles (none broke) |

The mechanical characteristics of Composition 2 are substantially similar to those of the Reference composition not containing a fluorinated compound according to the invention.

### Example 3

### Adhesion Test

The anti-adhesiveness of Composition 1 and of the Reference according to Example 1 were tested by applying to a sample thereof an uncured sample of bromobutyl rubber useful for manufacturing a pneumatic tyre inner liner (hereinafter referred to as “inner liner composition”), having the following components

| | | |
|---|---|---|
| BIIR (bromobutyl rubber) | 100 | phr |
| N660 | 50 | phr |
| Struktol ® 40 MS (homogenizing agent by Struktol Co.) | 4.0 | phr |
| Aromatic oil | 8.0 | phr |
| Stearic acid | 2.0 | phr |
| Magnesium oxide | 0.5 | phr |
| Zinc Oxide | 3.0 | phr |
| MBTS (dibenzothiazole disulfide) | 1.5 | phr |
| Sulphur | 0.5 | phr |

All of the samples had the same form and dimensions. Composition 1 and Reference composition were each adjoined to a sample of inner liner composition and placed under a hydraulic press with steam heated plates at a temperature of 170° C.±1° C. for 10 minutes±10 sec. The set forth conditions reproduce those of a pneumatic tyre vulcanisation using an expandable bladder. After this treatment, the minimum force used for separating the tested samples from each other was determined by a peeling test carried out by a dynamometer (Zwick Z005 of Zwick GmbH & Co. KG). A traction speed equal to 260 mm/min±20 mm/min was then applied and the peel force values thus measured, expressed in Newtons (N) (average of the force value for each sample). The results are set forth in Table 7.

TABLE 7

| Couple | Force (N) |
|---|---|
| Composition 1/inner liner composition | 0 (no adhesion) |
| Reference/inner liner composition | 59 |

Composition 1 according to the invention displays very good anti-adhesiveness properties with respect to the inner liner composition.

1-30. (canceled)

31. An expandable bladder for manufacturing pneumatic tyres, comprising an elastomeric material obtained by curing an elastomeric composition comprising at least one butyl rubber and at least one compound having at least one double bond and an at least partially fluorinated alkyl or polyoxyalkylene chain.

32. The expandable bladder according to claim 31, wherein the elastomeric composition comprises at least one fluorinated compound of formula (I): 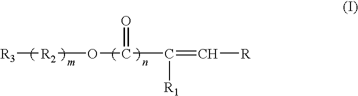
wherein
m and n are independently 0 or 1;
R is hydrogen or a methyl, ethyl, propyl or phenyl group;
R₁ is hydrogen or a (C₁-C₆)alkyl, aryl or aryl(C₁-C₄)alkyl group;
R₂ is a C₁-C₄ alkylene chain optionally comprising at least one group selected from —OH, —NH—, —NH₂, —O—, >CO and —CONH—; and
R₃ is a group selected from an at least partially fluorinated linear or branched C₄-C₂₀ alkyl chain, or a group having repeating units according to formula (Ia): 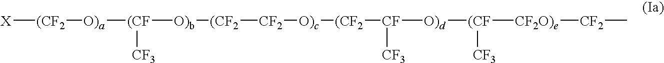
wherein (a+b+c+d)≧0;
a, b, c, d and e are independently zero or integers from 1 to 10;
said units being statistically distributed along the chain; and
X is hydrogen, fluoride, a CF₃ group or a group of formula (Ia′): 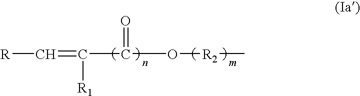
wherein m, n, R, R₁ and R₂ are defined above.

33. The expandable bladder according to claim 31, wherein the elastomeric composition comprises a curable rubber selected from natural rubber and synthetic isoprene rubber.

34. The expandable bladder according to claim 31, wherein the butyl rubber is an isobutyl rubber.

35. The expandable bladder according to claim 31, wherein the isobutyl rubber is a copolymer of isobutylene and at least one conjugated diene.

36. The expandable bladder according to claim 31, comprising 50 to 95 phr butyl rubber.

37. The expandable bladder according to claim 31, wherein the elastomeric composition comprises at least one elastomer selected from neoprene and chloroprene.

38. The expandable bladder according to claim 31, wherein the elastomeric composition comprises at least one cure system selected from sulphur cure and resin cure systems.

39. The expandable bladder according to claim 38, wherein the cure system is a resin cure system.

40. The expandable bladder according to claim 39, wherein the resin cure system is a resorcinol/formaldehyde resin cure system.

41. The expandable bladder according to claim 38, comprising 1 to 10 phr of the resin cure system.

42. The expandable bladder according to claim 38 wherein the sulphur cure system comprises 0.1 to 5 phr sulphur.

43. The expandable bladder according to claim 31, wherein the elastomeric composition comprises 0.1 to 6 phr of the compound of formula (I).

44. The expandable bladder according to claim 43, wherein the elastomeric composition comprises 1 to 4 phr of the compound of formula (I).

45. The expandable bladder according to claim 32, wherein R is hydrogen.

46. The expandable bladder according to claim 32, wherein R₁ is hydrogen.

47. The expandable bladder according to claim 32, wherein X is a group of formula (Ia′): 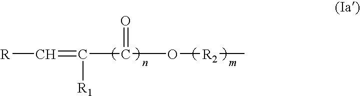
wherein n, R, R₁ and R₂ are defined in claim 32.

48. The expandable bladder according to claim 32, wherein R₃ is a C₄-C₂₀ at least partially fluorinated linear or branched alkyl chain.

49. The expandable bladder according to claim 48, wherein R₃ is a C₆-C₁₅ at least partially fluorinated linear or branched alkyl chain.

50. The expandable bladder according to claim 32, wherein R₃ is a C₄-C₂₀ at least partially fluorinated linear or branched alkyl chain and m is zero.

51. The expandable bladder according to claim 32, wherein R₃ is a group of formula (Ia), and m is 1.

52. The expandable bladder according to claim 51, wherein R₂ is a C₁-C₄ alkylene chain optionally comprising at least one group selected from —OH, —NH—, —NH₂, —O—, >CO and —CONH—.

53. The expandable bladder according to claim 52, wherein R₂ is a C₁-C₄ alkylene chain comprising at least one group selected from —OH, —O— and —CONH—.

54. The expandable bladder according to claim 32, wherein R₃ is totally fluorinated.

55. The expandable bladder according to claim 32, wherein the compound of formula (I) is an oligomer having a molecular weight of 500 to 3,000.

56. The expandable bladder according to claim 32, wherein the compound of formula (I) is selected from 2-perfluorohexylethylacrylate, perfluorohexylethylacrylate, perfluorooctylethylacrylate, perfluorododecylethylacrylate, perfluorooctylpropylacrylate, and perfluorooctyldecylacrylate.

57. A curable elastomeric composition comprising at least one curable rubber and at least one compound having at least one double bond and an at least partially fluorinated alkyl or polyoxyalkylene chain.

58. The curable elastomeric composition according to claim 57 comprising at least one compound of formula (I) 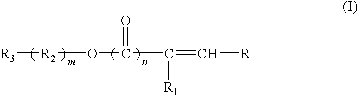
wherein
m and n are independently 0 or 1;
R is hydrogen or a methyl, ethyl, propyl or phenyl group;
R₁ is hydrogen or a (C₁-C₆)alkyl, aryl or aryl(C₁-C₄)alkyl group;
R₂ is a C₁-C₄ alkylene chain optionally comprising at least one group selected from —OH, —NH—, —NH₂, —O—, >CO and —CONH—; and
R₃ is a group selected from an at least partially fluorinated linear or branched C₄-C₂₀ alkyl chain, or a group having repeating units according to formula (Ia) 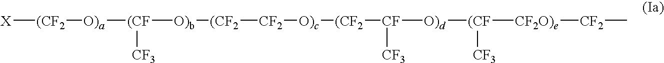
wherein (a+b+c+d)≧0;
a, b, c, d and e are independently zero or integers from 1 to 10;
said units being statistically distributed along the chain; and
X is hydrogen, fluoride, a CF₃ group or a group of formula (Ia′) 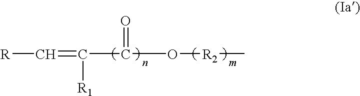
wherein m, n, R, R₁ and R₂ are defined above.

59. A process for manufacturing a pneumatic tyre, comprising the steps of
forming a crude tyre;
inserting the crude tyre in a vulcanisation mould; and
inserting an expandable bladder into the crude tyre;
wherein said expandable bladder comprises an elastomeric material obtained by curing an elastomeric composition comprising at least one butyl rubber and at least one compound having at least one double bond and an at least partially fluorinated alkyl or polyoxyalkylene chain.

60. A process for manufacturing a pneumatic tyre, comprising the steps of
forming a crude tyre;
inserting the crude tyre in a vulcanisation mould; and
inserting an expandable bladder into the crude tyre;
wherein said expandable bladder comprises an elastomeric material obtained by curing an elastomeric composition comprising at least one butyl rubber and at least one compound having at least one double bond and an at least partially fluorinated alkyl or polyoxyalkylene chain, the expandable bladder comprising at least one compound of formula I according to claim 32.
